(19) United States
(12) Patent Application Publication
(10) Pub. No.: US 2012/0324352 A1
(43) Pub. Date: Dec. 20, 2012

(54) CLIENT SERVER SYSTEM AND CLIENT DEVICE OF CLIENT SERVER SYSTEM

(75) Inventor: Shin IGAWA, Hino-shi (JP)

(73) Assignee: Konica Minolta Business Technologies, Inc., Chiyoda-ku (JP)

(21) Appl. No.: 13/490,617

(22) Filed: Jun. 7, 2012

(30) Foreign Application Priority Data
Jun. 15, 2011 (JP) 2011-133608

(51) Int. Cl. G06F 17/00; G06F 15/16

(52) U.S. Cl. 715/274; 709/203

(57) ABSTRACT

A server 2 is stored with a print setting program D which takes a form of a Rich Internet Application including an image edit section D6 for generating an image data (post-change image data) in which a change instruction at the time of print setting by a web application A has been reflected. A PC 1 is operable to download the print setting program D stored in the server 2 and to execute it on a web browser B in order to generate the post-change image data, thereby displaying it on the web browser B.

### CROSS-REFERENCE TO RELATED APPLICATION

This application is based on Japanese Patent Application No. 2011-133608 filed on Jun. 15, 2011, the contents of which are incorporated herein by reference.

### BACKGROUND

1. Technical Field

The present invention relates to a client server system including a client device with a web browser and a web server stored with a web application to be executed on the web browser, and to the client device of the client server system.

2. Description of Related Arts

A web application is an application for performing real operations on a web server according to various requests from a web browser connected through a network. Web applications have spread rapidly in recent years, because of advantages such as being easy to upgrade and being available without depending on an environment on a client side.

Conventionally, in order to print a document on the web application from a client terminal, the client terminal is required to install a software for print settings such as a printer driver. For that reason, printing documents using a new printer for the first time can introduce problems, such as, for example, the client terminal is required to search and install the printer driver corresponding to the new printer and, if the printer driver does not comply with the operating system of the client terminal, printing cannot be performed.

In order to solve the above-described problems, a system has been proposed in which a file to be printed can be transmitted to a server (such as a print server, a web server) from a web browser, with the system being capable of outputting the file to a printer through the server (refer to Japanese Unexamined Patent Publication No. 2010-225176). According to that system, image data for a preview is generated in the web server side according to print settings on the web browser, and therefore the user can set the print settings while checking the preview on the web browser. On the other hand, according to that system, in cases where the print settings are changed on the web browser, it is necessary to convert the file to be printed into the image data in a raster form again in the web server side, and to download it to the client side, thus a problem is pointed out that the performance of whole system can degrade.

### SUMMARY

In order to achieve at least one of the above-described objectives, a client server system reflecting one aspect of the present invention comprises a client device with a web browser, and a server with a web application to be executed on the web browser.

The server is stored with a rich internet application including a setting section which receives a change instruction of print settings for a file to be printed on the web application; a generating section which generates post-change image data representing the file in which the change instruction is reflected; and a display section which displays a preview of the file based on the post-change image data generated by the generating section.

The client device is operable to download the rich internet application stored in the server and to executes the rich internet application on the web browser.

Preferably, the generating section generates the post-change image data by editing pre-change image data representing image data for the file prior to reflection of the change instruction.

Preferably, the generating section generates the post-change image data by performing at least one of enlarging or reducing the pre-change image data, rearranging the pre-change image data, and superimposing other image data on the pre-change image data.

Preferably, each piece of other image data represents one of finishing functions which a printing device for printing the file has.

Preferably, the finishing functions include any of punching and stapling.

Preferably, the generating section generates the post-change image data by converting the file in accordance with the change instruction.

Preferably, the preview is an icon representing attribute information of the file.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram illustrating a structure of a client server system according to an embodiment of the present invention.

FIG. 2 is a block diagram illustrating a structure of a client device (PC) according to an embodiment of the present invention.

FIG. 3 is a block diagram illustrating a structure of a server according to an embodiment of the present invention.

FIG. 4 is a functional block diagram of a web application according to an embodiment of the present invention.

FIG. 5 is a functional block diagram of a print setting program according to an embodiment of the present invention.

FIG. 6 is a schematic diagram illustrating data flow between the PC and the server according to an embodiment of the present invention.

FIG. 7 is a flowchart illustrating the steps of the program starting process according to an embodiment of the present invention.

FIG. 8 is a flowchart illustrating the steps of the preview display process according to an embodiment of the present invention.

FIG. 9 is a schematic diagram illustrating an example of a preview of a document file according to an embodiment of the present invention.

FIG. 10 is a schematic diagram illustrating another example of the preview of the document file according to an embodiment of the present invention.

### DETAILED DESCRIPTION

The embodiments of this invention will be described below with reference to the accompanying drawings.

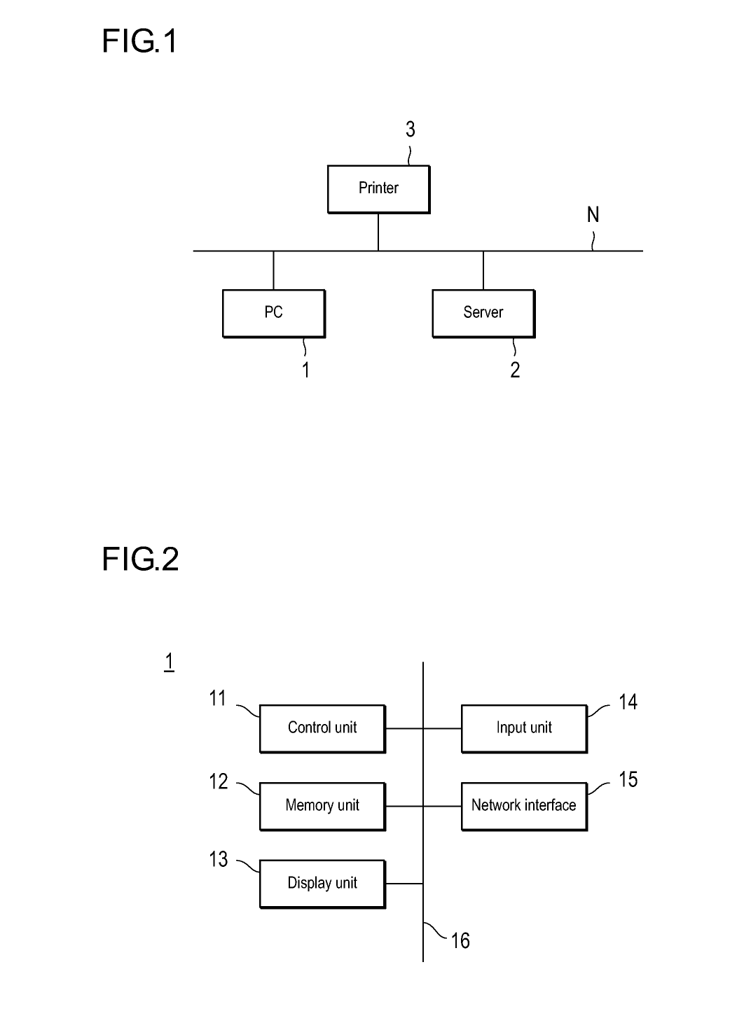

FIG. 1 is a block diagram illustrating a structure of a client server system (hereinafter, referred to as CS system) according to an embodiment of the present invention. As illustrated in FIG. 1, the CS system according to the present embodiment includes a PC 1 which serves as a client device, a server 2 which serves as a server of the CS system and a printer 3 which serves as a printing device.

A web browser B is installed in the PC 1 of the present embodiment. A web application A performed on the web browser B is installed on the server 2. A user of PC 1 can use the web application through the web browser B.

As illustrated in FIG. 1, the PC 1, the server 2, and the printer 3 are connected via a network N for exchanging signals. The network N may be a LAN complying with a standard such as Ethernet (registered trademark), Token Ring and FDDI, or a WAN in which LANs are connected to one another via a dedicated line, or the Internet. The types of the devices connected to the network N and the number of the devices are not limited to an example in the figure. HTTP may be used for communication between the PC 1 and the server 2 at the time of executing the web application A.

Next, structures of respective devices will be described below. Here, the printer 3 is a general printer such as a laser printer and an ink-jet printer, and therefore detailed descriptions will be omitted for the printer. FIG. 2 is a block diagram illustrating the structure of the PC 1 according to the present embodiment. As illustrated in FIG. 2, the PC 1 includes a control unit 11, a memory unit 12, a display unit 13, an input unit 14, and a network interface 15, and these units are connected by a bus 16 for exchanging signals. Details on these units will be described below.

The control unit 11 is a central control device (CPU), for controlling operations of respective units in accordance with programs, and for performing various calculation processes. The memory unit 12 is a storage area including a read only memory (ROM) for storing a program for controlling fundamental operations of the PC 1, parameters and the like, a random access memory (RAM) for temporarily retaining various kinds of data to serve as a working area for the CPU, and a hard disk drive (HDD) for storing various programs and data files and the like. The memory unit 12 includes a database for storing image data 12a to store image data for a preview display by a preview display section D4 (described below).

The display unit 13 is a display device such as a liquid crystal device (LCD), for displaying various information items to user. For example, the display unit 13 can display various user interface (UI) screens by the web browser B. The input unit 14 is an input device such as a keyboard and a mouse, for receiving various operational instructions from the user. The network interface 15 is a communication device such as a network interface card (NIC), for connecting the PC 1 to the network N.

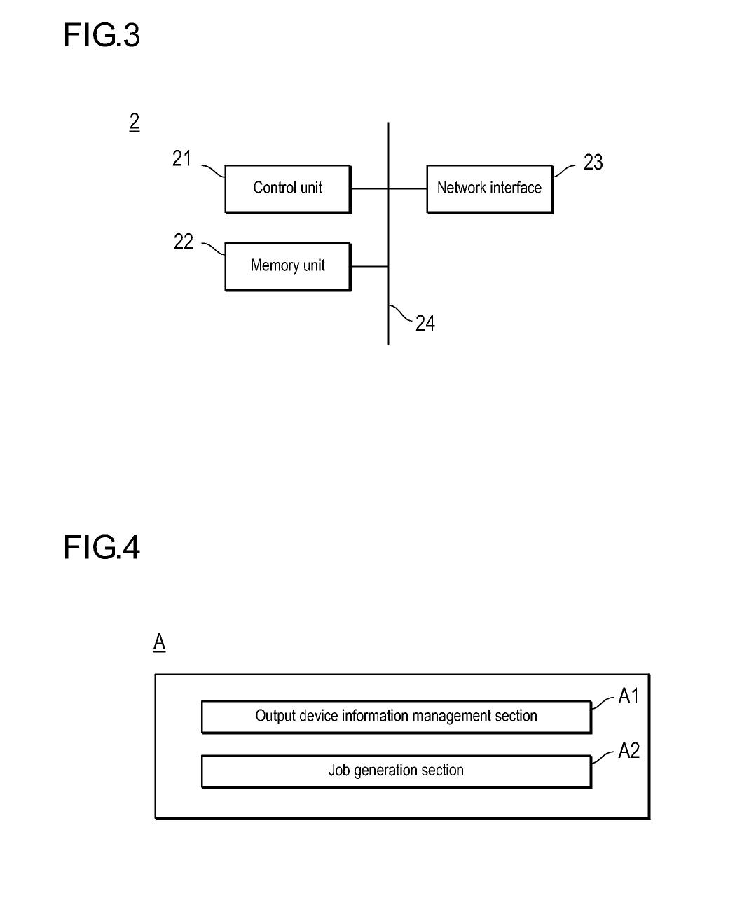

FIG. 3 is a block diagram illustrating the structure of the server 2 according to the present embodiment. As illustrated in FIG. 3, the server 2 includes a control unit 21, a memory unit 22, a network interface 23 and the like. These units are connected by a bus 24 for allowing two-way communications. Details on these units will be described below.

The control unit 21 is a central control device (CPU), for controlling operations of respective units in accordance with programs, and for performing various calculation processes. The memory unit 22 is a storage area including a ROM for storing program for controlling fundamental operation of the server 2, parameters and the like, a RAM for temporarily retaining various kinds of data to serve as a working area for the CPU, and a hard disk drive (HDD) for storing various programs and data files and the like. The memory unit 22 includes a database (DB) for storing document file 22a to store document files to be printed. The memory unit 22 stores a print setting program D (described below) for downloading to the PC 1. The network interface 23 is a communication device such as a network interface card (NIC), for connecting the server 2 to the network N.

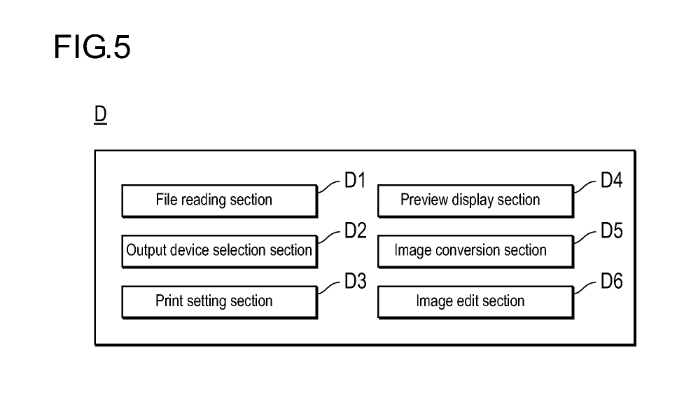

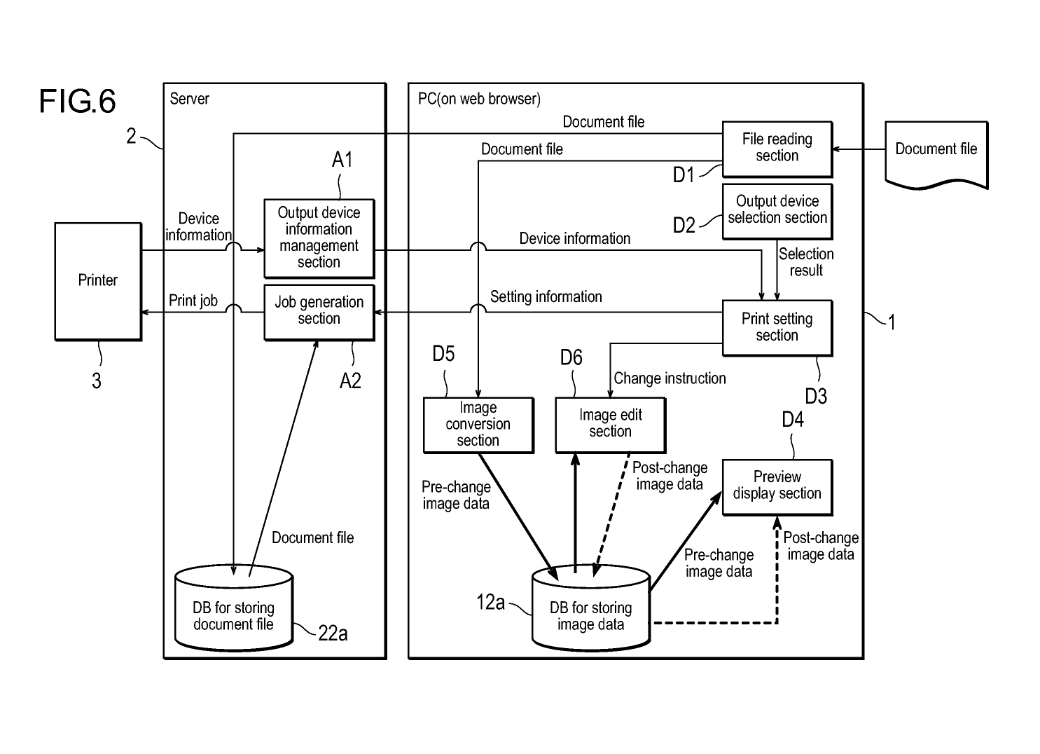

Next, the web application A installed on the server 2 will be explained. FIG. 4 is a functional block diagram of the web application A according to the present embodiment. As illustrated in FIG. 4, the web application A includes an output device information management section A1, and a job generation section A2, in addition to various modules which perform various processes according to user's request made through the browser B. These functions will be explained in detail with reference to FIG. 6. FIG. 6 is a schematic diagram illustrating data flow between the web application A and the print setting program D.

The output device information management section A1 communicates with printing devices (the printer 3 and the like) on the network N periodically, and acquires the information (hereinafter, referred to as “device information”) regarding print functions, finishing functions and the like of each of the devices. The device information in the present embodiment includes printing area, stapling position, punching position and the like of each of the devices. As illustrated in FIG. 6, the device information acquired by the output device information management section A1 is transmitted to a print setting section D3 at the time of performing the print settings of a document file. This will be further described below.

The job generation section A2 converts the document file in the DB for storing document file 22a into printing data (print job) in a form which can be processed by the printing device. As illustrated in FIG. 6, the print job generated by the job generation section A2 is transmitted to the printing device such as the printer 3 for a printing process.

Next, the print setting program P stored in the memory unit 22 of the server 2 will be explained. The print setting program D in the present embodiment is a Rich Internet Application (hereinafter, referred to as “RIA”) which uses HTML 5, Microsoft Silverlight (registered trademark), Adobe Flash (registered trademark) and the like. The print setting program D is downloaded from the server 2 to the PC1, and is performed on the web browser of the PC1 as described below.

FIG. 5 is a functional block diagram of the print setting program D. As illustrated in FIG. 5, the print setting program D includes a file reading section D1, an output device selection section D2, the print setting section D3, the preview display section D4, an image conversion section D5, and an image edit section D6. These components will be explained with reference to FIG. 6.

The file reading section D1 receives a selection result of a document file for printing from a user through the web browser B. More specifically, the file reading section D1 displays the UI screen (not illustrated) for selecting the document file on the web browser B, and makes a user select the document file for printing on the UI screen. As illustrated in FIG. 6, the document file selected by the user is transmitted to the image conversion section D5 and, is transmitted to the web server 2 through the network N to store it in the DB for storing document file 22a.

The output device selection section D2 receives a selection result of the printing device for printing the document file from the user through the web browser B. More specifically, the output device selection section D2 displays the UI screen (not illustrated) for selecting the output device on the web browser B, and makes the user select the printing device for printing the document file on the UI screen. As illustrated in FIG. 6, the user selected printing device is transmitted to the print setting section D3.

The print setting section D3 receives a change instruction of the print settings for the document file from the user through the web browser B. More specifically, the print setting section D3 displays the UI screen (not illustrated) for print settings on the web browser B, and makes the user enter the change instruction of the print settings for the document file on the UI screen. As illustrated in FIG. 6, the change instruction received by the print setting section D3 is transmitted to the image edit section D6.

In the present embodiment, the print setting section D3 can refer to the device information of the printing device selected by the user and, display the UI screen customized in accordance with the device information. The term, “customized print setting UI screen” as used herein refers to a UI screen in which buttons and check boxes and the like relating to functions (such as double-side printing, stapling, punching), which the printing device does not have, are grayed out.

The preview display section D4 displays the preview of the document file on the web browser B based on the image data in the DB for storing image data 12a. More specifically, the preview display section D4 displays the preview based on the image data first generated by the image conversion section D5 in cases where the change instruction has not been received by the print setting section D3. After the change instruction is received, the preview display section D4 displays the preview based on the image data in which the change instruction concerned has been reflected by the image edit section D6. Hereinafter, the image data in which the change instruction has been reflected by the image edit section D6 is referred to as “post-change image data”, and the image data in which the change instruction has not been reflected (namely, the image data first generated by the image conversion section D5) is referred to as “pre-change image data” for contrast with the “post-change image data”.

The image conversion section D5 generates the image data for the preview by image conversion (rasterizing) of the document file received from the file reading section D1. As illustrated in FIG. 6, the image data generated by the image conversion section D5 is stored into the DB for storing image data 12a in the memory unit 12.

Since the control unit 11 is under heavy high load when performing the image conversion, the image conversion section D5 in the present embodiment may be provided in the server 2 (web application A) side, instead of the PC 1 (print setting program D) side. In this case, it is possible to reduce the load of the control unit 11 in the preview display process which will be described below. Further, the image data before conversion generated by the server 2 side is transmitted to the PC 1 via the network N, and is stored into the DB for storing image data 12a.

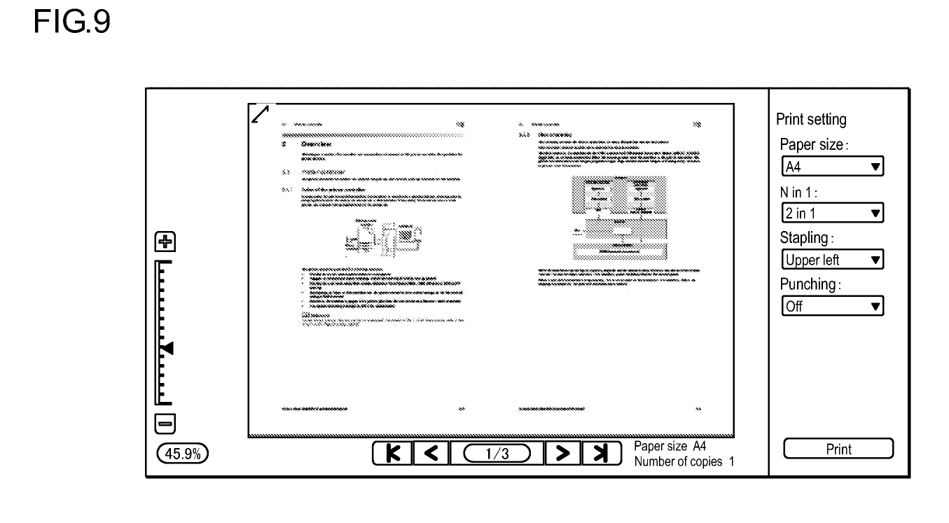

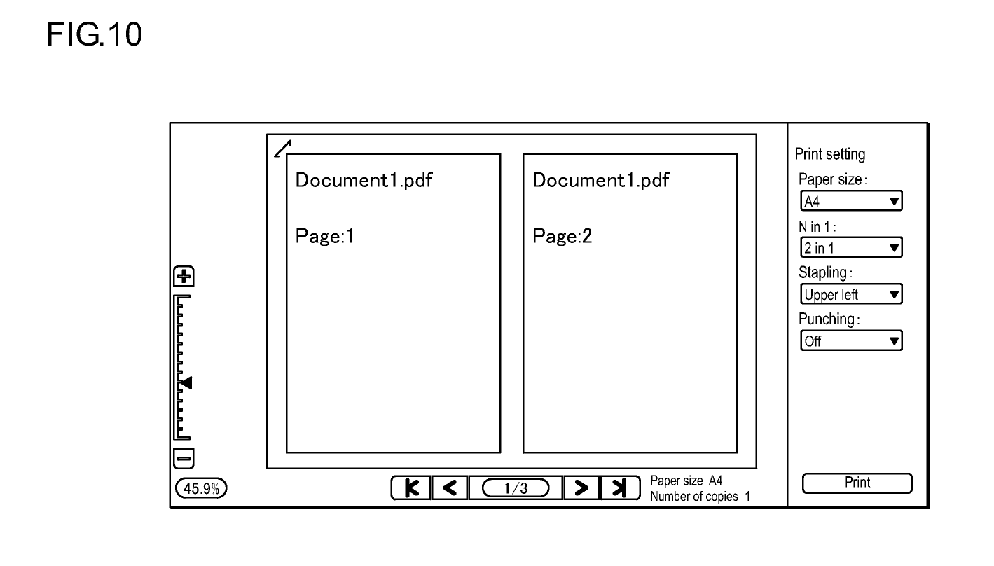

FIG. 9 and FIG. 10 are schematic diagrams illustrating examples of previews based on the pre-change image data generated by the image conversion section D5. The image conversion section D5 is capable of generating the image data which directly illustrates a printing result of the document file, as illustrated in FIG. 9. The image conversion section D5 is also capable of generating icons which illustrate only the attribute information (such as file name, paper size) on the document file as illustrated in FIG. 10. In addition, the image conversion section D5 is also capable of generating the image data in a vector form by vector conversion of the document file.

The image edit section D6 generates the post-change image data by editing the pre-change image data in the DB for storing image data 12a, according to the change instruction transmitted from the print setting section D3. More specifically, the image edit section D6 does not rasterize the document file again, but generates the post-change image data by enlarging/reducing the pre-change image data, rearranging the pre-change image data, or superimposing other image data on the pre-change image data. “Other image data” described herein represents image parts indicating the various finishing functions (such as the punching function, the stapling function) which the printing device selected by the user has. “Other image data” is stored in the memory unit 12 or the like of the PC 1 in advance.

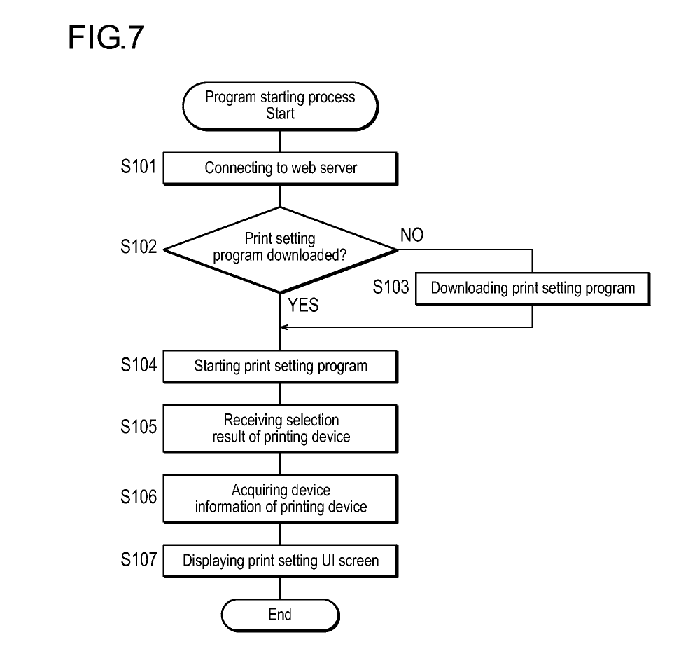

Next, an outline of operations of the CS system according to the present embodiment will be explained. FIG. 7 is a flowchart which illustrates steps of a process executed by the PC 1 in the present embodiment for starting the print setting program D and displaying the print setting UI screen (hereinafter, referred to as “program starting process”). This process is performed when a start instruction of the print settings is received. Besides, a control program according to the algorithm illustrated by the flowchart of FIG. 7 is stored in the ROM in the memory unit 12, and is read to the RAM when the process is launched.

First, the PC 1 connects to the server 2 through the network N by accessing URL of the server 2 from the web browser B (S101). The PC 1 then determines whether the print setting program D stored in the memory unit 22 of the server 2 has been downloaded (S102).

In cases where the print setting program D has been downloaded (S102: YES), the PC1 starts the print setting program D in the memory unit 12 (S104). In cases where the print setting program D has not been downloaded (S102: NO), the PC 1 downloads the print setting program D stored in the server 2 to the memory unit 12 (S103), and starts the print setting program D (S104). Alternatively, the steps of S101 to S104 may be performed at the time of the startup of the web application A by the web browser B, instead of being performed at the time of the print setting on the web application A as described above.

Next, the PC 1 receives the selection result of the printing device which prints the document file from the output device selection section D2 (S105). The PC 1 acquires the device information on the selected printing device from the output device information management section A1 of the server 2 (S106). Subsequently, the PC 1 generates the customized print setting UI screen by the print setting section D3 according to the device information acquired in the S106, displays the screen on the web browser B (S107), and ends a series of steps (end).

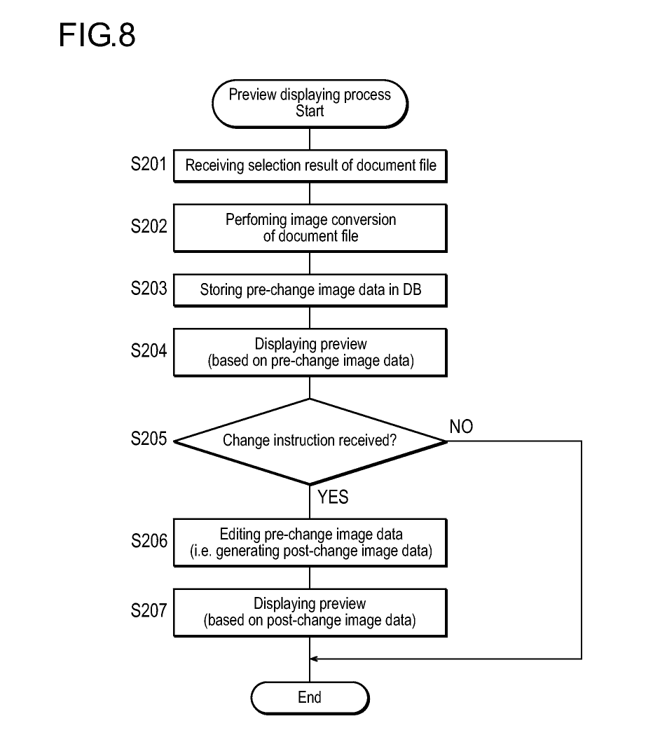

FIG. 8 is a flowchart which illustrates the procedure of the steps (hereinafter, referred to as “a preview display process”) for displaying the preview of the document file for printing by the PC 1 according to the present embodiment.

A control program according to the algorithm illustrated by the flowchart of FIG. 8 is stored in the ROM in the memory unit 12, and is read to the RAM when the process is launched.

First, the PC 1 receives the selection result of the document file by the file reading section D1 (S201), and thereafter performs image conversion (rasterizing) of the document file concerned by the image conversion section D5 (S202). Further, the PC 1 stores the pre-change image data generated by the image conversion section D5 in the DB for storing image data 12a (S203).

Here, in cases where the image conversion section D5 is provided in the server 2 side instead of the PC 1 side, the document file selected in the step S201 is transmitted to the server 2 through the network N, and the image conversion is performed in the server 2 side. The pre-change image data generated in the server 2 side is then transmitted to the PC 1 through the network N, and is stored in the DB for storing image data 12a.

The PC 1 displays the preview of the document file via the preview display section D4 based on the pre-change image data in the DB for storing image data 12a (S204). Subsequently, the PC 1 receives the change instruction of the print settings by the print setting section D3 (S205). Here, in cases where the PC 1 does not receive the change instruction (S205: No), the PC 1 ends a series of steps (End).

On the other hand, in cases where the change instruction is received (S205: YES), the PC 1 generates the post-change image data by editing the pre-change image data in the DB for storing image data 12a by the image edit section D6 (S206). For example, in cases where the setting item to be changed in accordance with the change instruction is any of “Page allocation”, “Single side/double-side” and the like, the post-change image data is generated by enlarging/reducing the pre-change image data as well as rearranging the pre-changed image.

Moreover, in cases where the setting item to be changed in accordance with the change instruction is any of “Stapling”, “Punching” and the like, the post-change image data is generated by superimposing the image parts corresponding to these functions on the pre-change image data. In this case, if the device information acquired in the step S106 illustrated in FIG. 7 includes the information on the stapling position (such as “Upper left”, “Upper right”), the image parts are preferably superimposed on the relevant stapling position.

The post-change image data generated in the step S206 is stored in the DB for storing image data 12a. In addition, since change instructions by the user may be repeated afterward, the pre-change image data generated in the step S202 is preferably held in the DB for storing image data 12a with the post-change image data. Moreover, in the step S206, the post-change image data may be generated by the image conversion section D5 instead of the image edit section D6. In this case, although the control unit 11 is under heavy load, it is possible to generate the post-change image data in which the change instruction is more correctly reflected, by performing the image conversion (rasterizing) again.

Subsequently, the PC 1 displays the preview based on the post-change image data in the DB for storing image data 12a (S207). That is, in the step S207, the preview of the document file, in which the change instruction has been reflected, is displayed based on the post-change image data generated by the image edit section D6 (or the image conversion section D5). The PC 1 then ends a series of steps (End).

In addition, in cases where a printing error occurs in the printing device side due to the changed print settings, the preview display section D4 can display the information on the printing error (an error message or the like), instead of the post-change image data or in addition to the post-change image data. For example, in cases where the printing device does not have the staple processing function even though the function is specified by the changed print settings, the preview display section D4 can display the error message “a staple process cannot be performed.”

As described above, the server 2 in the CS system according to the present embodiment is stored with the an Rich Internet Application including a generating section (i.e. “the image edit section D6”) to generate the image data (the post-change image data) in which the change instruction received at the time of the print setting for the document file by the web application A has been reflected. Further, the PC 1 in the CS system according to the present embodiment can generate the post-change image data by downloading the above-mentioned Rich Internet Application stored in the server 2 and executing the application on the web browser B, and display the generated post-change image data on the web browser B.

Therefore, according to the present embodiment, since the post-change image data can be generated in the PC 1 side even if the change instruction of the print settings is received on the web application A, it is not required to repeat the image conversion process (rasterizing) in the server 2 side. As a result, it is possible to effectively prevent a performance degradation of the whole system, which may occur at the time of the print setting by the web application A.

The present invention shall not be limited to the above-described embodiment, and hence it can be modified within the scope of the appended claims. For example, the client device according to the present invention may be any of devices which can execute the program downloaded on the web browser and, may be a smartphone, a tablet terminal and the like. Moreover, the server according to the present invention may be a general PC, and may be a computer built in the printing device or the like on a network. The printing device in this disclosure may be multi-functional peripheral (MFP) which includes a scanning function, a copying function and the like in addition to the printing function.

In addition, each device which constitutes the CS system according to the present invention can be implemented by a dedicated hardware circuit capable of executing the above-described steps, or by a computer program in which the above-described steps are listed. If implemented by the later one, the computer program for operating each device may be provided by a computer readable recording medium such as a floppy (registered trademark) disk or CD-ROM, or is provided on-line through a network such as Internet. The computer program recorded in the computer readable recording medium is normally transmitted to a ROM or a hard disk which are built in a memory device. The above-described program may be provided as a stand-alone application software program or, may be included in a software program as one of the functions of each device.

What is claimed is:

1. A client server system comprising: a client device with a web browser; and a server with a web application to be executed on said web browser, wherein
said server is stored with a rich internet application including: a setting section which receives a change instruction of print settings for a file to be printed on said web application; a generating section which generates post-change image data representing said file in which said change instruction is reflected; and a display section which displays a preview of said file based on said post-change image data generated by said generating section, and
said client device is operable to download said rich internet application stored in said server and to execute said rich internet application on said web browser.

2. The client server system as claimed in claim 1, wherein
said generating section generates said post-change image data by editing pre-change image data representing said file prior to reflection of said change instruction.

3. The client server system as claimed in claim 2, wherein
said generating section generates said post-change image data by performing at least one of enlarging or reducing said pre-change image data, rearranging said pre-change image data, and superimposing other image data on said pre-change image data.

4. The client server system as claimed in claim 3, wherein
each piece of said other image data represents one of finishing functions which a printing device for printing said file has.

5. The client server system as claimed in claim 4, wherein
said finishing functions include punching or stapling.

6. The client server system as claimed in claim 1, wherein
said generating section generates said post-change image data by converting said file in accordance with said change instruction.

7. The client server system as claimed in claim 1, wherein
said preview is an icon representing attribute information of said file.

8. A client device of a client server system including a server with a web application, being operable to download a rich internet application stored in said server and to execute said rich internet application on a web browser, wherein
said rich internet application includes: a setting section which receives a change instruction of print settings for a file to be printed on said web application; a generating section which generates post-change image data representing said file in which said change instruction is reflected; and a display section which displays a preview of said file based on said post-change image data generated by said generating section.

9. The client device as claimed in claim 8, wherein
said generating section generates said post-change image data by editing pre-change image data representing said file prior to reflection of said change instruction.

10. The client device as claimed in claim 9, wherein
said generating section generates said post-change image data by performing at least one of enlarging or reducing said pre-change image data, rearranging said pre-change image data, and superimposing other image data on said pre-change image data.

11. The client device as claimed in claim 10, wherein
each piece of said other image data represents one of finishing functions which a printing device for printing said file has.

12. The client device as claimed in claim 11, wherein
said finishing functions include punching or stapling.

13. The client device as claimed in claim 8, wherein
said generating section generates said post-change image data by converting said file in accordance with said change instruction.

14. The client device as claimed in claim 8, wherein
said preview is an icon representing attribute information of said file.
